(19) United States
(12) Patent Application Publication
(10) Pub. No.: US 2016/0182761 A1
(43) Pub. Date: Jun. 23, 2016

(54) IMAGE FORMING APPARATUS

(71) Applicant: KYOCERA Document Solutions Inc., Osaka (JP)

(72) Inventor: Masayuki Tobinaga, Osaka (JP)

(21) Appl. No.: 14/972,160

(22) Filed: Dec. 17, 2015

(30) Foreign Application Priority Data
Dec. 18, 2014 (JP) 2014-255817

(51) Int. Cl. H04N 1/44; H04N 1/00

(52) U.S. Cl. CPC H04N 1/4413; H04N 1/0032; H04N 1/00204; H04N 2201/0094

(57) ABSTRACT

An image forming apparatus includes an authentication unit, a storing unit, an image reading unit, a printing unit, a determination unit, and a control unit. The authentication unit performs user authentication upon printing of an image of a document. The storing unit stores image data in advance. The image reading unit reads an image of a document. The printing unit forms and prints an image on the basis of the document image read by the image reading unit. The determination unit determines whether the document image read by the image reading unit has a relation with the image data stored in the storing unit. The control unit performs control, in response to determination by the determination unit that the document image read by the image reading unit has a relation with the image data stored in the storing unit, to activate the printing unit, without activating the authentication unit.

### INCORPORATION BY REFERENCE

The disclosure of Japanese Patent Application No. 2014-255817 filed on Dec. 18, 2014 including the specification, drawings, and abstract is incorporated herein by reference in its entirety.

### BACKGROUND

The present disclosure relates to image forming apparatuses.

In image forming apparatuses typified by a digital multifunctional peripheral and the like, an image of a document is read by an image reading unit and a photoreceptor included in an image forming unit is irradiated with light based on the read image, so an electrostatic latent image is formed on the photoreceptor. A developer such as charged toner is supplied onto the electrostatic latent image to form a visible image, which is transferred and fixed onto a sheet of paper. The sheet is then discharged to the outside of the apparatus.

In printing devices which form images for output, those which print content displayed by a Web browser are conventionally known.

A typical printing device is equipped with a Web browser which acquires, from an external device, content designated by a user using a bookmark, and displays the content. This printing device includes: a printing unit configured to print content displayed by the Web browser; a displaying unit configured to display a setting screen which enables setting, on one and the same screen, whether to inhibit or permit the editing of a bookmark and whether to inhibit or permit the printing of content by the printing unit; and a control unit which inhibits the editing of the bookmark in the case where the result of the setting on the setting screen indicates that the editing of the bookmark is inhibited, permits the editing of the bookmark in the case where the result of the setting on the setting screen indicates that the editing of the bookmark is permitted, inhibits the printing of the content in the case where the result of the setting on the setting screen indicates that the printing of the content is inhibited, and permits the printing of the content in the case where the result of the setting on the setting screen indicates that the printing of the content is permitted. In this printing device, designation of content using a bookmark can be accepted from a user both in the case where the result of the setting on the setting screen indicates that the editing of the bookmark is inhibited and in the case where the result of the setting on the setting screen indicates that the editing of the bookmark is permitted.

### SUMMARY

In an aspect of the present disclosure, an image forming apparatus includes an authentication unit, a storing unit, an image reading unit, a printing unit, a determination unit, and a control unit. The authentication unit performs user authentication upon printing of an image of a document. The storing unit stores image data in advance. The image reading unit reads an image of a document. The printing unit forms and prints an image on the basis of the image of the document read by the image reading unit. The determination unit determines whether the image of the document read by the image reading unit has a relation with the image data stored in the storing unit. The control unit performs control, in response to determination by the determination unit that the image of the document read by the image reading unit has a relation with the image data stored in the storing unit, to activate the printing unit, without activating the authentication unit.

### BRIEF DESCRIPTION OF THE DRAWINGS

FIG. 1 schematically shows an appearance of a digital multifunctional peripheral in the case where an image forming apparatus according to an embodiment of the present disclosure is applied to the digital multifunctional peripheral;

FIG. 2 is a block diagram showing the configuration of the digital multifunctional peripheral in the case where an image forming apparatus according to an embodiment of the present disclosure is applied to the digital multifunctional peripheral;

FIG. 3 is an appearance diagram schematically showing the configuration of an operation unit;

FIG. 4 is a conceptual diagram showing the content of image data stored in a hard disk;

FIG. 5 shows an example of a display screen of the operation unit in the case of performing user authentication;

FIG. 6 is a flowchart illustrating a process flow in the case where the digital multifunctional peripheral according to an embodiment of the present disclosure is used to form and print an image;

FIG. 7 schematically shows a document set on a document setting unit;

FIG. 8 is a flowchart illustrating a process flow of the digital multifunctional peripheral in the case where user authentication is performed; and

FIG. 9 is a conceptual diagram showing the content of image data stored in a hard disk according to another embodiment of the present disclosure.

### DETAILED DESCRIPTION

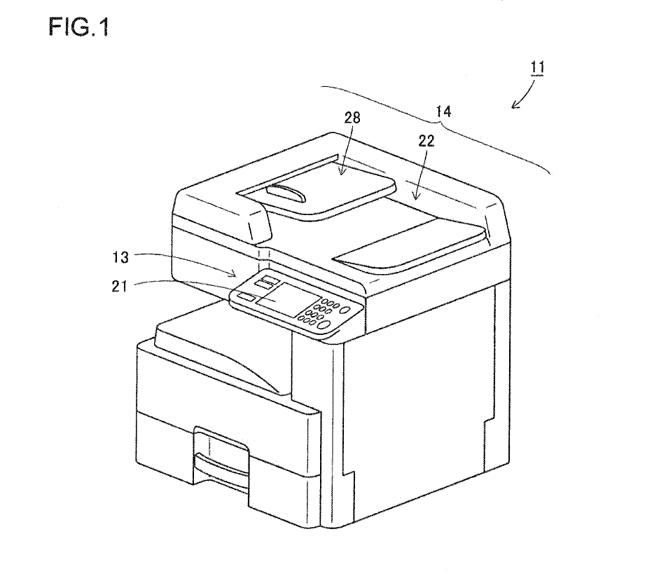

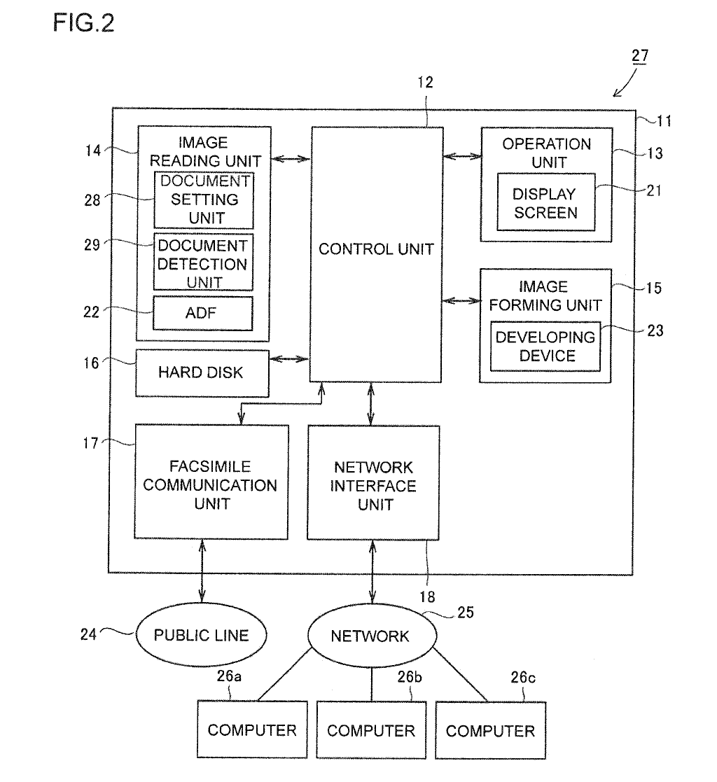

Embodiments of the present disclosure will be described below. First, the configuration of a digital multifunctional peripheral in the case where an image forming apparatus according to an embodiment of the present disclosure is applied to the digital multifunctional peripheral will be described. FIG. 1 schematically shows an appearance of such a digital multifunctional peripheral. FIG. 2 shows the configuration of the digital multifunctional peripheral.

Referring to FIGS. 1 and 2, the digital multifunctional peripheral 11 includes: a control unit 12; an operation unit 13; an image reading unit 14; an image forming unit 15; a hard disk 16 as a storing unit; a facsimile communication unit 17; and a network interface unit 18 for connecting with a network 25. The control unit 12 is responsible for overall control of the digital multifunctional peripheral 11. The operation unit 13 includes a display screen 21 for displaying information originated from the digital multifunctional peripheral 11 side and content input by a user. The operation unit 13 causes a user to set image forming conditions, such as the number of copies and gradation, and to turn the power on or off The image reading unit 14 includes a document setting unit 28 on which a document is set for reading an image thereof, a document detection unit 29 which detects that a document has been set on the document setting unit 28, and an auto document feeder (ADF) 22 as a document feeding unit which feeds the document that has been set on the document setting unit 28, to a place where an image of the document is read. The image reading unit 14 reads an image of a document. The image forming unit 15 includes a developing device 23 which uses toner for development. The image forming unit 15 forms an image on the basis of image data which has been read or on the basis of image data received via the network 25. The hard disk 16 stores, among others, the image data received, and the image forming conditions input. The facsimile communication unit 17, which is connected to a public line 24, performs facsimile transmission and reception. Although the digital multifunctional peripheral 11 further includes a dynamic random access memory (DRAM) to and from which image data is written and read, and other components, the illustration and description thereof will be omitted. The arrows shown in FIG. 2 indicate flows of control signals as well as data related to control and images.

The digital multifunctional peripheral 11 operates as a copier by forming an image in the image forming unit 15 using the image data of the document read by the image reading unit 14. The digital multifunctional peripheral 11 operates as a printer by forming an image and printing the image on a sheet of paper in the image forming unit 15 using image data received from a computer 26a, 26b, or 26c connected to the network 25, via the network interface unit 18. That is, the image forming unit 15 operates as the printing unit which prints a requested image. Further, the digital multifunctional peripheral 11 operates as a facsimile machine by forming an image in the image forming unit 15 via the DRAM using the image data received from the public line 24 through the facsimile communication unit 17, or by transmitting the image data of the document read by the image reading unit 14 to the public line 24 through the facsimile communication unit 17. As such, the digital multifunctional peripheral 11 has a plurality of functions related to image processing, such as a copying function, function as a printer, facsimile function, etc. The digital multifunctional peripheral 11 further has a function enabling detailed settings for each of the above functions.

An image forming system 27 including the digital multifunctional peripheral 11 includes the digital multifunctional peripheral 11 which has the above configuration, and a plurality of computers 26a, 26b, 26c each connected to the digital multifunctional peripheral 11 via the network 25. In the present embodiment, three computers 26a-26c are shown as the plurality of computers. Each computer 26a, 26b, 26c is able to issue a print request to the digital multifunctional peripheral 11 via the network 25 for printing. The digital multifunctional peripheral 11 and the computers 26a-26c may be connected via wire using a local area network (LAN) cable or the like, or they may be connected wirelessly. Another digital multifunctional peripheral or a server may also be connected in the network 25.

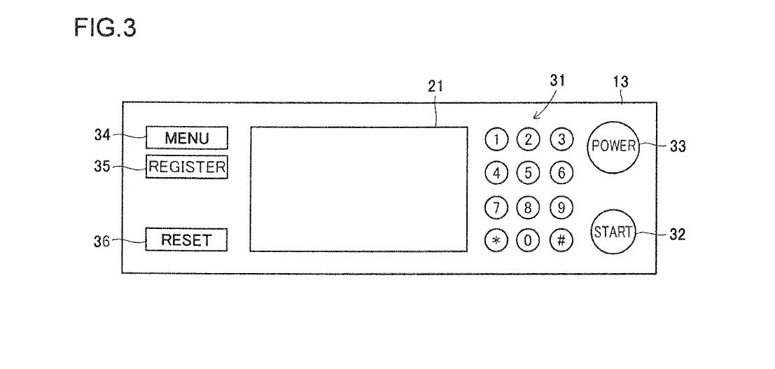

The configuration of the above-described operation unit 13 will now be described in more detail. FIG. 3 shows a schematic configuration of the operation unit 13. Referring to FIG. 3, the operation unit 13 includes: a numeric keypad 31 including the numeric keys 0 to 9 for inputting the number of copies and the like, and symbol keys “*” and “#”; a start key 32 for instructing to start printing or facsimile transmission; a power key 33 for turning the digital multifunctional peripheral 11 on or off; a menu key 34 for selecting a function such as the printing or copying function included in the digital multifunctional peripheral 11; a register key 35 for registering various image forming conditions as well as users; a reset key 36 for canceling the content of instruction input by a user using the numeric keypad 31 or the like; and the display screen 21 described above. The display screen 21 has a liquid crystal touch panel function, and allows a user to press the screen with his/her finger(s) to input the image forming conditions and select the functions via the display screen 21 as well.

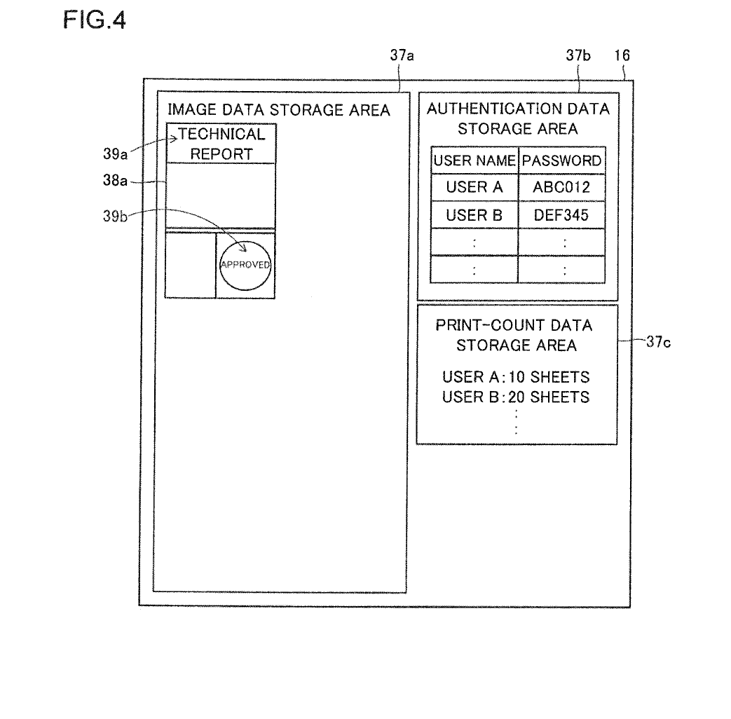

The content of data stored in the hard disk 16 will now be described. FIG. 4 is a conceptual diagram showing the content of image data stored in the hard disk 16. Referring to FIG. 4, the hard disk 16 has an image data storage area 37a allocated for storing image data in advance, an authentication data storage area 37b allocated for storing data on user authentication, and a print-count data storage area 37c allocated for storing data on the number of printed sheets. In the image data storage area 37a, a piece of image data 38a is stored in advance. This piece of image data 38a is image data on a format of a technical report, and includes a plurality of frame lines, character data, and graphic data. Specifically, in the area corresponding to the top of the sheet of the image data 38a, character data 39a reading “Technical Report” is arranged. In the area corresponding to the lower right of the sheet of the image data 38a, graphic data 39b in the shape of a seal or stamp is arranged, with characters “Approved” shown therein.

In the authentication data storage area 37b allocated in the hard disk 16, data on user names and passwords associated with the corresponding user names are stored. FIG. 4 shows the state where the password “ABC012” is stored, associated with the user name “user A”, and the password “DEF345; ” is stored, associated with the user name “user B”.

Further, in the print-count data storage area 37c allocated in the hard disk 16, data on user names and the numbers of sheets printed under the corresponding user names are stored. FIG. 4 shows the state where data on the number of printed sheets “10 sheets” is stored, associated with the user name “user A”, and data on the number of printed sheets “20 sheets” is stored, associated with the user name “user B”. Each time printing is performed in the digital multifunctional peripheral 11 under the name of a certain user, the number of printed sheets is counted. Such numbers of printed sheets are accumulated for individual users and stored as the print-count data for the respective users.

It should be noted that the data stored in the image data storage area 37a, the authentication data storage area 37b, and the print-count data storage area 37c allocated in the hard disk 16 can be manipulated using the numeric keypad 31 in the operation unit 13 or the like. That is, for example, a user can use the numeric keypad 31 or the like to make the user name and the password associated with each other and stored as data in the authentication data storage area 37b.

The digital multifunctional peripheral 11 includes an authentication unit which performs user authentication upon printing of an image of a document. The authentication unit authenticates a user who uses the digital multifunctional peripheral 11.

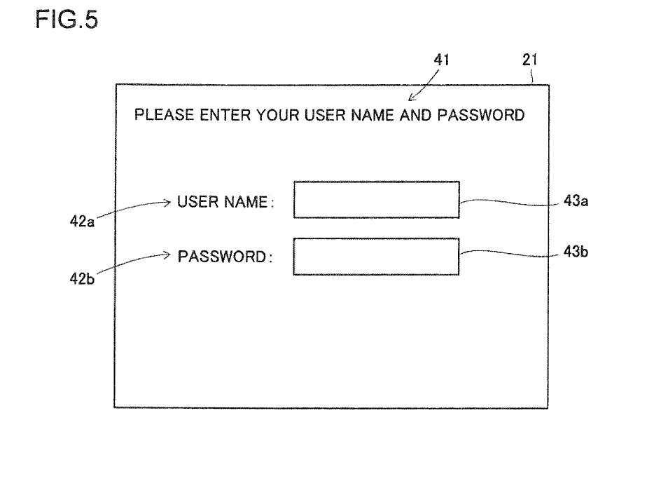

FIG. 5 shows an example of the display screen 21 of the operation unit 13 in the case of performing user authentication. Referring to FIG. 5, the following are displayed on the display screen 21: a message 41 reading “Please enter your user name and password”, an indication 42a reading “user name” for prompting the user to enter the user name, an indication 42b reading “password” for prompting the user to enter the password that the user him/herself knows and that is associated with the user name, a user name field 43a for the user to enter the user name therein, and a password field 43b for the user to enter the password therein. The control unit 12 performs user authentication by determining whether the set of the user name and the password that the user has entered into the user name field 43a and the password field 43b using the numeric keypad 31 or the like is included in a plurality of sets of user names and passwords associated with the respective user names that are stored in advance in the authentication data storage area 37b in the hard disk 16. Here, the control unit 12 operates as the authentication unit.

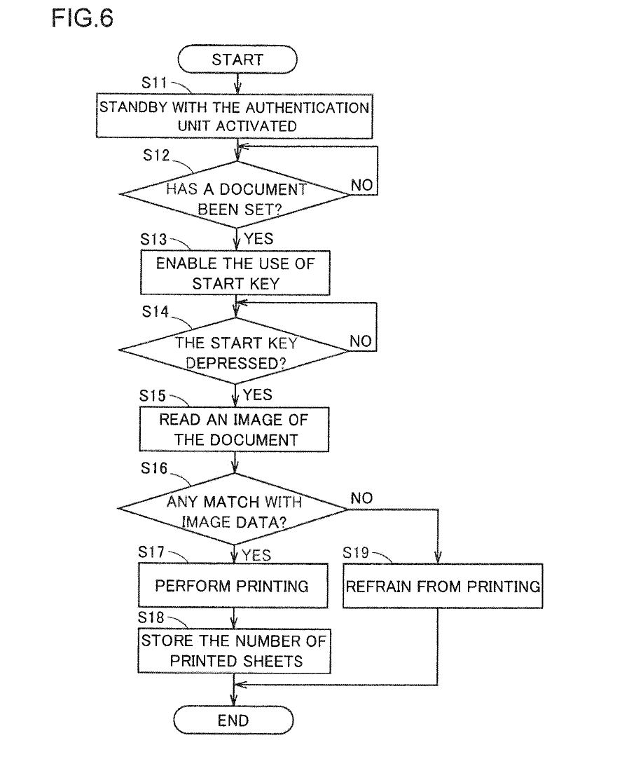

The case of forming and printing an image using the digital multifunctional peripheral 11 according to an embodiment of the present disclosure will now be described. FIG. 6 is a flowchart illustrating a process flow in the case of using the digital multifunctional peripheral 11 according to an embodiment of the present disclosure to form and print an image.

Referring to FIG. 6, the digital multifunctional peripheral 11 is on standby, with the authentication unit being activated (step S11 in FIG. 6; the term “step” will be omitted below). That is, the apparatus is on standby, with the display screen 21 shown in FIG. 5 being displayed.

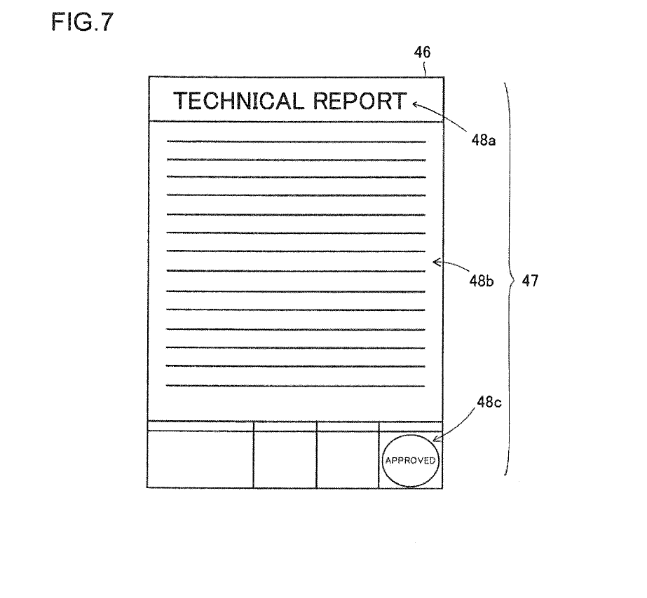

The user sets a document in the document setting unit 28 included in the ADF 22. FIG. 7 schematically shows a document set on the document setting unit 28. Referring to FIG. 7, an image 47 of the document 46 includes: characters 48a reading “Technical Report” written in the area on the top of the document 46, characters 48b as the content of the report, written in the center area of the document 46, a graphic 48c in the shape of a stamp with characters “Approved” shown therein, arranged in the area at the lower right of the document 46, and frame lines for partitioning them. Such a document 46 is set on the document setting unit 28.

When detecting that a document 46 has been set on the document setting unit 28 (YES in S12), the digital multifunctional peripheral 11 enters a state enabling the ADF 22 to feed the document. In this case, the apparatus enables the use of the start key 32 included in the operation unit 13 (S13). That is, the apparatus becomes ready to start feeding the document 46 set on the document setting unit 28 in response to depression of the start key 32.

Thereafter, when detecting the depression of the start key 32 (YES in S14), the digital multifunctional peripheral 11 reads an image 47 of the document 46 (S15). That is, it causes the ADF 22 to feed the document 46 set on the document setting unit 28, and reads the image 47 of the document 46.

The digital multifunctional peripheral 11 then determines whether the image 47 of the document 46 read by the image reading unit 14 has a relation with the image data 38a stored in the hard disk 16. In this case, the apparatus determines whether the image 47 of the document 46 read by the image reading unit 14 at least partially matches the image data 38a stored in the hard disk 16 (S16). Here, the control unit 12 operates as the determination unit. In this case, the digital multifunctional peripheral 11 determines that the characters 48a reading “Technical Report”, written in the area on the top of the document 46, and the graphic 48c in the shape of the stamp with the characters “Approved” shown therein, arranged in the area at the lower right of the document 46 match the character data 39a reading “Technical Report”, in the area corresponding to the top of the sheet of the image data 38a, and the graphic data 39b in the shape of the stamp with the characters “Approved” shown therein, in the area corresponding to the lower right of the sheet of the image data 38a, respectively.

If it is determined that the image 47 of the document 46 read by the image reading unit 14 at least partially matches the image data 38a stored in the hard disk 16 (YES in S16), the digital multifunctional peripheral 11 performs printing without performing authentication by the authentication unit (S17). That is, the apparatus activates the printing unit, and forms and prints the image by the image forming unit 15. The digital multifunctional peripheral 11 then stores the number of printed sheets into the hard disk 16 (S18), and the process is terminated. In this case, user authentication was not performed and, thus, the user name cannot be identified, so the number of printed sheets is stored in association with an arbitrary user name.

On the other hand, if it is determined that the image 47 of the document 46 read by the image reading unit 14 does not match the image data 38a stored in the hard disk 16 (NO in S16), the process is terminated, with no printing performed (S19).

With this configuration, when it is determined that the image 47 of the document 46 read by the image reading unit 14 has a relation with the image data 38a stored in the hard disk 16, the digital multifunctional peripheral 11 performs control to activate the printing unit, without activating the authentication unit. This enables forming and printing the image having a relation with the image data 38a stored in the hard disk 16, while skipping the authentication procedure. Thus, for example in the case of printing a fixed form document, a user can print the desired document, without the need to enter the password. This can reduce the work burden of the user.

In this case, the digital multifunctional peripheral 11 performs control, in response to the detection by the document detection unit 29 that a document 46 has been set on the document setting unit 28, to enter the state enabling the ADF 22 to feed the document 46, without activating the authentication unit. This further facilitates the reading of the image 47 of the document 46.

It may also be configured such that, when it is determined that the image of the document read by the image reading unit 14 has no relation with the image data stored in the hard disk 16, the digital multifunctional peripheral 11 determines whether to activate the printing unit or not, on the basis of the result of authentication performed by the authentication unit.

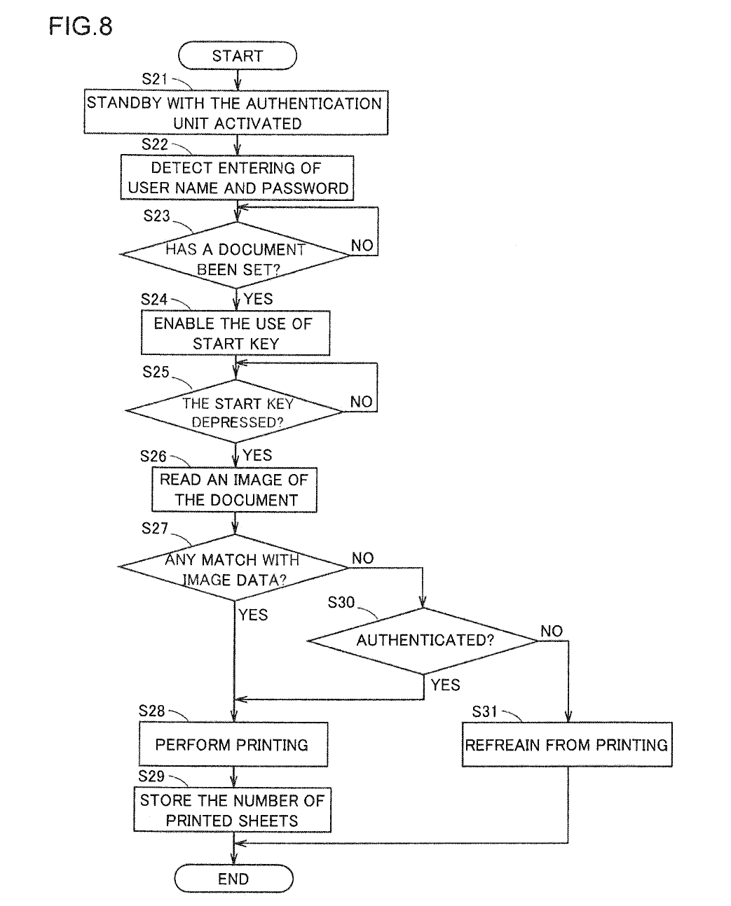

FIG. 8 is a flowchart illustrating a process flow of the digital multifunctional peripheral in such a case. Referring to FIG. 8, the digital multifunctional peripheral 11 is on standby, with the display screen 21 shown in FIG. 5 being displayed, with the authentication unit being activated (S21).

Next, a user enters the user name and the password into the user name field 43a and the password field 43b, respectively. Then, the digital multifunctional peripheral 11 detects the entering of the user name and the password (S22).

Thereafter, when detecting that a document 46 has been set on the document setting unit 28 (YES in S23), the digital multifunctional peripheral 11 enables the use of the start key 32 included in the operation unit 13 (S24). Thereafter, when detecting the depression of the start key 32 (YES in S25), the digital multifunctional peripheral 11 reads an image 47 of the document 46 (S26).

The digital multifunctional peripheral 11 then determines whether the image 47 of the document 46 read by the image reading unit 14 at least partially matches the image data 38a stored in the hard disk 16 (S27).

If it is determined that the image 47 of the document 46 read by the image reading unit 14 at least partially matches the image data 38a stored in the hard disk 16 (YES in S27), the digital multifunctional peripheral 11 performs printing, without performing authentication by the authentication unit (S28). It then stores the number of printed sheets into the hard disk 16 (S29), and the process is terminated.

On the other hand, if it is determined that the image 47 of the document 46 read by the image reading unit 14 does not match the image data 38a stored in the hard disk 16 (NO in S27), the digital multifunctional peripheral 11 now determines whether the user is authenticated by the authentication unit (S30). That is, it is determined whether the set of the user name and the password entered into the user name field 43a and the password field 43b agrees with one of a plurality of sets of user names and passwords stored in the authentication data storage area 37b in the hard disk 16.

If the user is authenticated by the authentication unit (YES in S30), i.e. if one of the sets of user names and passwords stored in the authentication data storage area 37b in the hard disk 16 agrees with the set of the user name and the password entered into the user name field 43a and the password field 43b, then the digital multifunctional peripheral 11 forms and prints an image on the basis of the read image (S28). Then, the number of printed sheets is stored in the hard disk 16 (S29), and the process is terminated. In this case, the number of printed sheets thus counted is accumulated and stored in relation to the user name of the authenticated user.

On the other hand, if the user is not authenticated (NO in S30), i.e. if the set of the user name and the password entered into the user name field 43a and the password field 43b does not agree with any of the sets of user names and passwords stored in the authentication data storage area 37b in the hard disk 16, then the process is terminated with no printing performed (S31).

With this configuration, in the case where an image of a document other than the fixed form document is to be printed, the printing can be performed on the basis of the result of authentication by the authentication unit. This makes it possible to appropriately manage the number of printed sheets for each user. This also makes it possible to disallow the printing by an unauthenticated user.

In the above embodiment, when printing is performed, the number of printed sheets is stored into the hard disk. The configuration, however, is not limited thereto; the number of printed sheets may not be stored into the hard disk.

Further, in the above embodiment, it is determined that the image of the document that has been read has a relation with the image data stored in the storing unit when the characters “Technical Report” and the image of the stamp with the characters “Approved” shown therein included in the document image both match the corresponding parts in the image data. The configuration, however, is not limited thereto. It may be configured to determine that they have a relation with each other when at least one of the above parts matches. It may also be configured to determine that they have a relation with each other, even when both of the above parts do not match, if the stamps are similar in shape, or if they differ only in color.

In the above embodiment, one piece of image data is stored in advance in the hard disk. The configuration, however, is not limited thereto; two or more pieces of image data may be stored in advance in the hard disk.

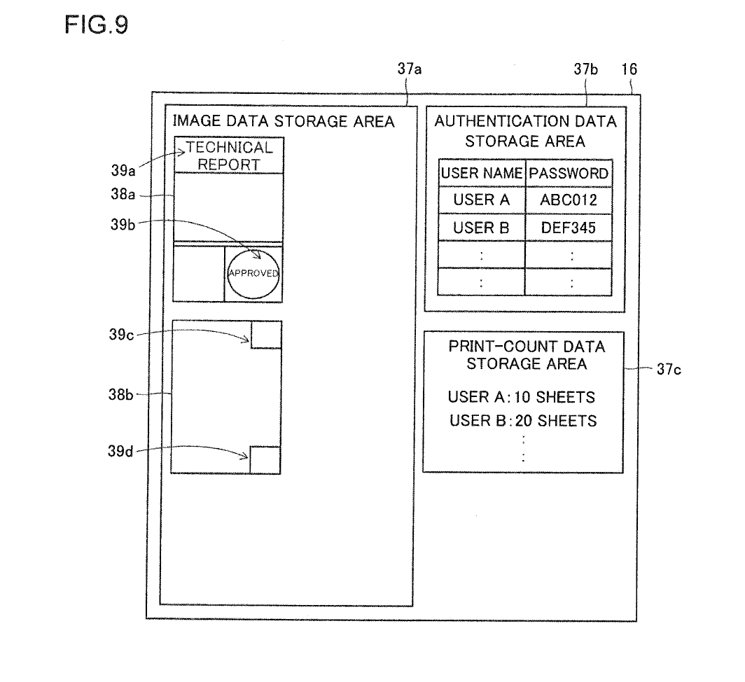

FIG. 9 is a conceptual diagram showing the content of image data stored in the hard disk according to another embodiment of the present disclosure. Referring to FIG. 9, two pieces of image data, 38a and 38b, are stored in the image data storage area 37a in the hard disk 16. The image data 38b has rectangular frame lines made up of line data 39c and 39d in the areas corresponding respectively to the upper right and the lower right of a sheet. With this configuration, the determination as to whether the image of the document read has a relation with any of the image data stored can be made in a wider range, using a plurality of pieces of image data 38a and 38b.

In the above embodiments, the hard disk is used as the storing unit. The configuration, however, is not limited thereto; an external storage device, for example, may be adopted as the storing unit. Further, the authentication unit may authenticate a user using only the user name, or using another parameter in addition to the user name and the password.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

The image forming apparatus according to the present disclosure is applicable particularly advantageously to the case where the reduction in work burden of a user is required.

What is claimed is:

1. An image forming apparatus comprising:
an authentication unit configured to perform user authentication upon printing of an image of a document;
a storing unit configured to store image data in advance;
an image reading unit configured to read an image of a document;
a printing unit configured to form and print an image on the basis of the image of the document read by the image reading unit;
a determination unit configured to determine whether the image of the document read by the image reading unit has a relation with the image data stored in the storing unit; and
a control unit configured to perform control, in response to determination by the determination unit that the image of the document read by the image reading unit has a relation with the image data stored in the storing unit, to activate the printing unit, without activating the authentication unit.

2. The image forming apparatus according to claim 1, wherein in the case where the image of the document read by the image reading unit at least partially matches the image data stored in the storing unit, the determination unit determines that the image of the document has a relation with the image data.

3. The image forming apparatus according to claim 1, wherein
the image reading unit includes a document setting unit on which a document is set, a document detection unit which detects that a document has been set on the document setting unit, and a document feeding unit which feeds the document set on the document setting unit to a place where an image of the document is read, and
the control unit performs control, in response to detection by the document detection unit that a document has been set on the document setting unit, to enter a state enabling the feeding of the document by the document feeding unit, without activating the authentication unit.

4. The image forming apparatus according to claim 1, wherein in the case where the determination unit determines that the image of the document read by the image reading unit has no relation with the image data stored in the storing unit, the control unit determines whether to activate the printing unit or not, on the basis of the result of the authentication by the authentication unit.

5. The image forming apparatus according to claim 1, wherein the image data stored in the storing unit includes at least one of image data of a fixed form document and image data of a stamp.

6. The image forming apparatus according to claim 1, wherein the control unit performs control to store the number of printed sheets into the storing unit in conjunction with activation of the printing unit.

7. The image forming apparatus according to claim 1, wherein the storing unit stores a plurality of pieces of said image data in advance.
